(19) United States
(12) Patent Application Publication
(10) Pub. No.: US 2010/0260153 A1
(43) Pub. Date: Oct. 14, 2010

(54) METHOD FOR DATA TRANSMISSION IN A MESH MODE OF A WIRELESS COMMUNICATION NETWORK

(76) Inventors: Matthias Hollick, Darmstadt (DE); Parag Sudhir Mogre, Darmstadt (DE); Christian Schwingenschlögl, Putzbrunn (DE)

Correspondence Address: King & Spalding LLP, 401 Congress Avenue, Suite 3200, Austin, TX, 78701, US

(21) Appl. No.: 12/747,322

(22) PCT Filed: Dec. 5, 2008
(86) PCT No.: PCT/EP08/66840

§ 371 Date: Jun. 10, 2010

(30) Foreign Application Priority Data
Dec. 11, 2007 (EP) 07024010.6
May 9, 2008 (EP) 08008789.3

(51) Int. Cl. H04J 3/00

(52) U.S. Cl. 370/336

(57) ABSTRACT

In a method for data transmission in a mesh mode of a wireless communication network, which enables a decentralized transmission of data packets within data streams via communication links from one node to another node, data streams are classified in several service classes specifying quality requirements for data streams. Bandwidth reservations are performed between nodes of a communication link, each bandwidth reservation being dependent on the service class of the data stream to be transmitted via the communication link and comprising the exchange of control messages for reserving time slots for transmitting the data stream of the service class in subsequent data time frames via the communication link. The transmission of data streams is scheduled dependent on the service classes. The method is particularly used in the mesh mode of the standard IEEE 802.16 and enables a seamless coexistence of the point-to-multipoint mode and the mesh mode of the standard.

### CROSS-REFERENCE TO RELATED APPLICATIONS

This application is a U.S. National Stage Application of International Application No. PCT/EP2008/066840 filed Dec. 5, 2008, which designates the United States of America, and claims priority to EP Application No. 07024010.6 filed Dec. 11, 2007 and EP Application No. 08008789.3 filed May 9, 2008. The contents of which are hereby incorporated by reference in their entirety.

### TECHNICAL FIELD

The invention refers to a method for data transmission in a mesh mode of a wireless communication network as well as to a network node and a corresponding communication network.

### BACKGROUND

Wireless communication networks are often operated in a so-called mesh node in which data packets are transmitted hop by hop between neighboring network nodes in a decentralized manner. In such an operation mode, QoS support (QoS=Quality of Service) is usually handled on a packet-by-packet basis.

The wireless communication standard IEEE 802.16 (IEEE=Institute of Electrical and Electronic Engineers) is a broadband wireless access standard enabling wireless communication between nodes based on a point-to-multipoint mode as well as on a mesh mode. The point-to-multipoint mode defines several QoS parameters for different service classes based on bandwidth requirements for data streams. Contrary to that, the mesh mode in this standard provides QoS only for single data packets, e.g. by assigning a priority to the MAC protocol data units to be transmitted in the mesh mode.

### SUMMARY

According to various embodiments, a method for data transmission in a mesh mode of a communication network enabling an enhanced QoS support can be provided.

According to an embodiment, a method for data transmission in a mesh mode of a wireless communication network, the mesh mode enabling a decentralized transmission of data packets within data streams via communication links from one node to another node in the communication network, may comprise: —classifying data streams in service classes specifying quality requirements for the data streams of the respective service class; —performing bandwidth reservations for data streams between nodes of a communication link, each bandwidth reservation being dependent on the service class of the data stream to be transmitted via the communication link and comprising the exchange of control messages for reserving time slots for transmitting the data stream of the service class in subsequent data time frames via the communication link; —scheduling the transmission of data streams via the communication link in dependency on the service classes of the data streams.

According to a further embodiment, the data can be transmitted as MAC protocol data units on the MAC layer in the mesh mode of the standard IEEE 802.16. According to a further embodiment, the control messages can be MAC management messages, particularly MSH-DSCH messages. According to a further embodiment, a service class can be mapped to values of one or more fields in the mesh connection identifier of a MAC protocol data unit or to values of at least one of the fields Reliability, Priority/Class, and Drop Precedence. According to a further embodiment, the bandwidths of the data streams can be estimated and the bandwidth reservations depend on the estimated bandwidths of the data streams. According to a further embodiment, the service classes may comprise a first service class for real-time data streams having variablesized data packets issued periodically and wherein at least one time slot per communication link is reserved for all subsequent data time frames in order to transmit control messages of bandwidth reservations for data streams of the first service class. According to a further embodiment, the service classes may comprise a first service class for real-time data streams having variable-sized data packets issued periodically and wherein at least one time slot per communication link is reserved for all subsequent data time frames in order to transmit control messages of bandwidth reservations for data streams of the first service class, and the first service class may correspond to the rtPS service class in the PMP mode of the standard IEEE 802.16. According to a further embodiment, the bandwidth reservation for data streams of the first service class may be valid for time slots of a finite number of subsequent data time frames. According to a further embodiment, the service classes may comprise a second service class specifying real-time data streams having fixed-sized data packets issued periodically. According to a further embodiment, the service classes may comprise a second service class specifying real-time data streams having fixed-sized data packets issued periodically, and the time slots may be reserved for data streams of the second service class are at least partially usable for transmitting at least one of control messages and data streams of the first service class. According to a further embodiment, the service classes may comprise a second service class specifying real-time data streams having fixed-sized data packets issued periodically, and the second service class may correspond to the UGS service class of the PMP mode of the standard IEEE 802.16. According to a further embodiment, the control messages of the bandwidth reservation for data streams of the second service class can be exchanged in control time frames. According to a further embodiment, the bandwidth reservation for data streams of the second service class may be valid for time slots of all subsequent data time frames in the future. According to a further embodiment, the service classes further may comprise at least one of a third service class specifying non-real-time data streams having variable-sized data packets with a minimum data rate requirement and a fourth service class specifying non-real-time data streams without any data rate requirement. According to a further embodiment, the service classes further may comprise at least one of a third service class specifying non-real-time data streams having variable-sized data packets with a minimum data rate requirement and a fourth service class specifying non-real-time data streams without any data rate requirement, and the third service class may correspond to the nrtPS service class of the PMP mode of the standard IEEE 802.16 and/or the fourth service class corresponds to the BE service class of the PMP mode of the standard IEEE 802.16. According to a further embodiment, the bandwidth reservations for data streams of at least one of the third and fourth service class can be valid for time slots of a finite number of subsequent data time frames. According to a further embodiment, the control messages of the bandwidth reservations for data streams of at least one of the third and fourth service class may be exchanged in control time frames. According to a further embodiment, the service classes may comprise a first service class for real-time data streams having variable-sized data packets issued periodically and at least one time slot per communication link may be reserved for all subsequent data time frames in order to transmit control messages of bandwidth reservations for data streams of the first service class, the service classes may comprise a second service class specifying real-time data streams having fixed-sized data packets issued periodically, and the transmission of the data streams may be scheduled by a weighted fair queuing scheduler such that the second and first and third and fourth data streams are served with weights in decreasing order. According to a further embodiment, the service classes may comprise a first service class for real-time data streams having variable-sized data packets issued periodically and wherein at least one time slot per communication link is reserved for all subsequent data time frames in order to transmit control messages of bandwidth reservations for data streams of the first service class, the service classes may comprise a second service class specifying real-time data streams having fixed-sized data packets issued periodically, and wherein data streams of the first and second service classes are allowed to borrow bandwidth reserved for data streams of the fourth service class but not for data streams of the third service class. According to a further embodiment, the control messages in a data time frame can be served with higher priority than the data streams in the data time frame. According to a further embodiment, the data streams can be classified based on information in the network layer or in the IP layer. According to a further embodiment, the control messages exchanged during bandwidth reservation may comprise messages for requesting, granting and grant-confirming reserved time slots and a node having sent a control message for granting reserved time slots and not receiving a corresponding control message for grant-confirming within a predetermined time may send a grant revoke message for revoking the reservation of the reserved time slots. According to a further embodiment, a node not receiving data from another node in already reserved timeslots within a pre-defined time may send a grant revoke message for revoking the reservation of the reserved timeslots. According to a further embodiment, the grant revoke message may specify the time slots granted by the node in combination with a cancelling instruction. According to a further embodiment, the control messages exchanged during bandwidth reservation may comprise messages for requesting, granting and grant-confirming reserved time slots and a node having sent a control message for granting reserved time slots and not receiving a corresponding control message for grant-confirming within a predetermined time may send a grant revoke message for revoking the reservation of the reserved time slots, and the grant revoke message can be specified by a revoke bit in the grant information element of the MSH-DSCH message of the standard IEEE 802.16.

According to another embodiment, a Network node for data transmission in a mesh mode of a wireless communication network, the mesh mode enabling a decentralized transmission of data packets within data streams via communication links from the network node to other nodes in the communication network, may comprises: —means for classifying data streams arriving in the network node in service classes specifying quality requirements for data streams of the respective service class; —means for managing bandwidth reservations for data streams, said bandwidth reservations being performed between the network node and neighboring nodes of a communication link, wherein each bandwidth reservation is dependent on the service class of the data stream to be transmitted via the communication link and comprising the exchange of control messages for reserving time slots for transmitting the data stream of the service class in subsequent data time frames via the communication link; —means for scheduling the trans-mission of data streams from the network node via the communication link in dependency on the service classes of the data streams.

According to a further embodiment of the network node, the network node is adapted for performing a method as described above.

According to yet another embodiment, a communication network may comprise several network nodes as described above.

### BRIEF DESCRIPTION OF THE DRAWINGS

Various embodiments will now be described with respect to the accompanying drawings, wherein:

FIG. 1 shows a topology in the point-to-multipoint mode of operation in the wireless communication standard IEEE 802.16;

FIG. 2 shows a topology in the mesh mode of operation in the wireless communication standard IEEE 802.16;

FIG. 3 shows a diagram illustrating the principles of data transmission in a network node according to one embodiment;

FIG. 4 shows the mapping of service classes to fields in a MESH connection identifier according to one embodiment; and

FIG. 5 shows the structure of a MSH-DSCH message used in one embodiment for controlling data streams based on service classes.

### DETAILED DESCRIPTION

The method according to various embodiments refers to a mesh mode of operation in a wireless communication network. The mesh mode enables the decentralized transmission of data packets within data streams via communication links from one node to another node in the communication network. This means that communication links are defined decentrally between neighboring nodes in the network. According to various embodiments, data streams are classified in service classes specifying quality requirements for the data streams of the respective service class. The term “quality” refers to any parameters which may be used to specify the quality of a data stream, e.g. traffic priority, minimum reserved rate, tolerated jitter, maximum sustained rate, maximum traffic burst, maximum latency and scheduling service. Contrary to a packet-by-packet QoS support, the quality requirements are now defined for data streams and, thus, particularly include bandwidth requirements which cannot be assigned to a single data packet. In order to handle such quality requirements, bandwidth reservations for data streams are performed between nodes of a communication link, each reservation being dependent on the service class of the data stream to be transmitted via the communication link and comprising the exchange of control messages for reserving time slots for transmitting the data stream of the service class in subsequent data time frames via the communication link. Furthermore, the transmission of data streams is scheduled in dependency on the service classes of the data streams.

The various embodiments enable an efficient handling of data stream based service classes by making bandwidth reservations for time slots in data time frames (i.e. in time frames used for transmitting data rather than control messages) dependent on the service class of the data stream. Furthermore, the transmission schedule of the data streams is also depending on the data stream based service classes.

In an embodiment, the data is transmitted as MAC protocol data units on the MAC layer in the mesh mode of the standard IEEE 802.16. This standard is a well-known wireless communication standard which is specified in document [1]. The whole disclosure of this document is incorporated by reference in this application. In the context of this standard, the bandwidth reservations correspond to a three-way handshake comprising messages for request, grant and grant-confirmation for reserving minislots, said minislots being time slots in the sense of claim 1. The control messages being exchanged in bandwidth reservations are preferably the so-called MAC management messages according to the IEEE 802.16 standard, particularly the so-called MSH-DSCH messages which are used for coordinated and/or uncoordinated scheduling in this standard.

In another embodiment using the standard IEEE 802.16, a service class is mapped to values of one or more fields in the mesh connection identifier of a MAC Protocol data unit, particularly to values of the fields Reliability and/or Priority/Class and/or Drop Precedence.

In another embodiment of the method, the bandwidths of the data streams are estimated and the bandwidth reservations depend on the estimated bandwidths of the data streams.

In an embodiment, the service classes comprise a first service class for real-time data streams having variable-sized data packets issued periodically, wherein at least one time slot per communication link is reserved for all subsequent data time frames in order to transmit control messages of bandwidth reservations for data streams of the first service class. This embodiment takes into account that real-time data streams having variable-sized data packets require an immediate reservation for bandwidth. Such an immediate reservation is ensured by permanently reserving (i.e. for all subsequent data time frames in the future) time slots for control messages of bandwidth reservations for data streams belonging to this service class. As such reservations are made in data time frames, control messages for the first service class are transmitted in data time frames and not in control time frames which are normally used for control messages.

In an embodiment using the standard IEEE 802.16, the first service class corresponds to the so-called rtPS service class (rtPS=real-time polling service) in the PMP mode (PMP=point-to-multipoint) of the standard IEEE 802.16. Hence, this embodiment enables the use of the rtPS service class originally defined for the PMP mode in the mesh mode of the standard IEEE 802.16.

In another embodiment, the bandwidth reservation for data streams of the first service class is valid for time slots of a finite number of subsequent data time frames. This ensures that bandwidth is not reserved for a long term, thus lowering the risk of collisions which may occur when control messages for bandwidth reservations are transmitted within data time frames as it is the case for the control messages of bandwidth reservations for data streams of the first service class.

In another embodiment, the service classes comprise a second service class specifying real-time data streams having fixed-sized data packets issued periodically. Preferably, the time slots being reserved for data streams of the second service class are at least partially usable for transmitting control messages and/or data streams of the first service class. I.e., to ensure a minimum delay, traffic from the first service class can borrow bandwidth reserved for traffic of the second service class. Traffic of the second service class can then borrow bandwidth back from the reserved bandwidth for the first service class as soon as the bandwidth reservation has been terminated.

In an embodiment, the second service class corresponds to the UGS service class (UGS=unsolicited grant service) of the PMP mode of the standard IEEE 802.16, thus enabling a seamless coexistence of this service class in both the mesh mode and the PMP mode of the standard IEEE 802.16.

In an embodiment, the control messages of the bandwidth reservations for data streams of the second service class are exchanged in control time frames provisioned for the exchange of such control messages. In the context of the IEEE standard 802.16, these control time frames are designated as control subframes.

In another embodiment, the bandwidth reservations for data streams of the second service class are valid for time slots of all subsequent data time frames.

In another embodiment, the service classes comprise a third service class specifying non-real-time data streams having variable-sized data packets with a minimum data rate requirement and/or a fourth service class specifying non-real-time data streams without any data rate requirement. Preferably, when using the standard IEEE 802.16, the third service class corresponds to the nrtPS service class (nrtPS=non-real-time polling service) of the PMP mode of the standard IEEE 802.16 and/or the fourth service class corresponds to the BE service class (BE=best effort) of the PMP mode of the standard IEEE 802.16. Preferably, the bandwidth reservation for the third and/or fourth service class is valid for time slots of a finite number of subsequent data time frames. This ensures that time slots are not blocked permanently for those service classes. Furthermore, the control messages of the bandwidth reservations for data streams of the third and/or fourth service class are preferably exchanged in control time frames.

In an embodiment using all of the above defined first, second, third and fourth service classes, the data streams are scheduled by a weighted fair queuing scheduler such that the second and the first and the third and the fourth data streams are served with weights in decreasing order, i.e. the second data stream has a higher priority than the first data stream and the first data stream has a higher priority than the third data stream and the third data stream has a higher priority than the fourth data stream.

Preferably, data streams of the first and second service classes are allowed to borrow bandwidth reserved for data streams of the fourth service class but not for data streams of the third service class.

In another embodiment, the control messages in a data time frame are served with higher priority than the data streams in the data time frame.

In another embodiment, the data packets are classified based on information in the network layer, particularly in the IP layer.

In an embodiment, the control messages exchanged during bandwidth reservation comprise messages for requesting, granting and grant-confirming reserved time slots wherein a node having sent a control message for granting reserved time slots and not receiving a corresponding grant-confirmation within a predetermined time sends a grant revoke message for revoking the reservation of the reserved time slots. This mechanism enables the release of blocked time slots in case of a failed bandwidth reservation.

In another embodiment, already reserved time slots may be cancelled later on. To do so, a node which does not receive data in already reserved timeslots within a predefined time sends a grant revoke message for revoking the reservation of the time slots.

The above defined grant revoke message needs not to specified separately. Particularly, it just can be a message including the granted time slots in combination with a cancelling instruction. This cancelling instruction particularly corresponds to a persistence value 0. This persistence value will be described later on in the detailed description. Nevertheless, when using the IEEE standard 802.16, the grant revoke message may be specified by a revoke bit in the grant information element of the MSH-DSCH message of this standard.

Besides the above method, various embodiments relate to a network node for data transmission in a mesh mode of a wireless communication network, the mesh mode enabling a decentralized transmission of data packets within data streams via communication links from the network node to other nodes in the communication network. The network node comprises the following components:
means for classifying data streams arriving in the network node in service classes specifying quality requirements for data streams of the respective service class;
means for managing bandwidth reservations for data streams, said bandwidth reservations being performed between the network node and neighboring nodes of a communication link, wherein each bandwidth reservation is dependent on the service class of the data stream to be transmitted via the communication link and comprising the exchange of control messages for reserving time slots for transmitting the data stream of the service class in subsequent data time frames via the communication link;
means for scheduling the transmission of data streams from the network node via the communication link in dependency on the service classes of the data streams.

The aforementioned network node is preferably adapted to perform any of the aforementioned methods for data transmission. Furthermore, the various embodiments refer to a network comprising several of the aforementioned network nodes.

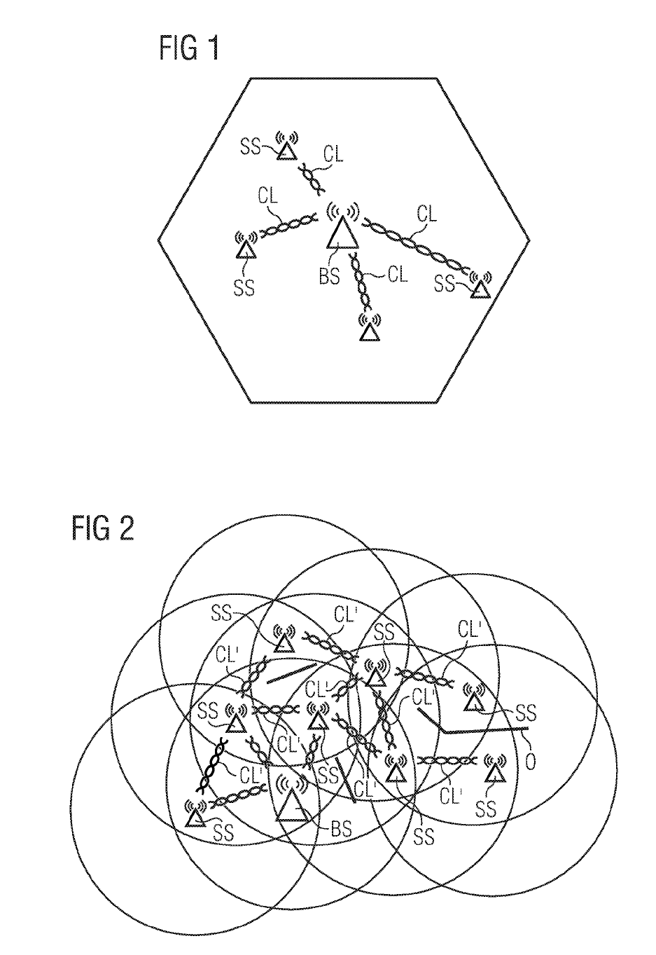

In the following, the various embodiments are explained based on the IEEE standard 802.16 which is a wireless communication standard supporting metropolitan area networks, rural networks or enterprise wide networks. This standard specifies two modes of operation. The first mode is shown in FIG. 1 and refers to the so-called point-to-multipoint mode (PMP). In this mode, several nodes being subscriber stations SS communicate directly by communication links CL with a central node being a base station, as can be seen from FIG. 1. Direct communication between two subscriber stations SS is not supported in the PMP mode. A further mode of operation is the so-called MESH mode shown in FIG. 2. In this mode, the subscriber stations SS are allowed to establish communication links between neighboring nodes and are able to communicate with each other directly as indicated by corresponding communication links CL′ in FIG. 2. Furthermore, obstacles occurring between the nodes in the network are designated with reference signs O. The subscriber stations SS also are able to send traffic to and receive traffic from corresponding base stations BS (a base station in the MESH mode is treated as a subscriber station SS which provides backhaul services to the MESH network). The MESH mode of the IEEE standard 802.16 allows for flexible growth in the coverage of the MESH network and increases the robustness of the network due to the provision of multiple alternate paths for communication between nodes.

The IEEE standard 802.16 has an extensive support for QoS (QoS=Quality of Service) at the MAC layer (MAC=Medium Access Control). In addition, the IEEE standard 802.16 outlines a set of physical layer specifications which can be used with a common MAC layer. This flexibility allows the network to operate in different frequency bands based on the users' needs and the corresponding regulations.

Various embodiments as explained in the following refer to an implementation of the QoS support provided in the PMP mode of IEEE 802.16 to the MESH mode. For better understanding, the principles of the QoS support in the 802.16 PMP mode will be explained first before describing its extension to the MESH mode according to various embodiments.

Quality of Service is provisioned in the PMP mode on a per-connection basis. All data either from a subscriber station SS to the base station BS or vice versa is transmitted within the context of a connection, identified by the connection identifier CID specified in the MAC protocol data unit PDU. The CID is a 16-bit value that identifies a connection to equivalent peers in the MAC at both the base stations BS as well as the subscriber stations SS. It also provides a mapping to a service flow identifier SFID. This identifier defines the QoS parameters which are associated with a given connection. The SFID is a 32-bit value and is one of the core concepts of the MAC protocol. It provides a mapping of the QoS parameters for a particular data entity.

Typical service parameters associated with a service flow are traffic priority, minimum reserved rate, tolerated jitter, maximum sustained rate, maximum traffic burst, maximum latency, and scheduling service. The base station BS may optionally create a service class which is a name given to a particular set of QoS parameters and which can be considered as a macro for specifying a set of QoS parameters typically used. The value for the scheduling service parameter in the QoS parameter set specifies the data scheduling service associated with a service flow. The IEEE 802.16 standard currently defines the following data scheduling service classes: unsolicited grant service (UGS), real-time polling service (rtPS), non-real-time polling service (nrtPS) and best effort (BE). According to various embodiments described later on, these service classes in the PMP mode are supported by the MESH mode as well.

The UGS service class supports real-time data streams consisting of fixed-sized data packets issued periodically. The rtPS service class supports data streams having variable-sized data packets issued at periodic intervals. The nrtPS service class is designed to support delay-tolerant streams of variable-sized data packets for which a minimum data rate is expected. The data traffic based on the BE service class is serviced on a space-available basis without any bandwidth requirements. For service flows associated with the scheduling service class UGS, the base station BS allocates a static amount of bandwidth to the subscriber station SS in every frame. The amount of bandwidth granted by the basis station BS for this type of scheduling service depends on the maximum sustained traffic rate of the service flow. For rtPS service flows, the base station BS offers real-time, periodic, unicast request opportunities meeting the flow's requirements and allowing the subscriber stations SS to request a grant of the desired size. For nrtPS, the base station BS—similar to the case of a rtPS service flow—offers periodic request opportunities. However, those request opportunities are not real-time and the subscriber station SS can also use contention based request opportunities in addition to the unicast request opportunities for a nrtPS service flow as well as the unsolicited data grant types. For a BE service flow, no periodic polling opportunities are granted. The service station SS uses contention request opportunities, unicast request opportunities and unsolicited data grant burst types. Summarized, the PMP mode of the IEEE standard 802.16 provides a base station BS with efficient means to manage the bandwidth optimally and at the same time satisfy the requirements of the individual admitted service flows.

According to the state of the art, there also exists a QoS support in the 802.16 MESH mode. However, this support is provisioned on a packet-by-packet basis and does not enable the definition of bandwidth requirements for corresponding service classes. However, according to the embodiment as described in the following, the above mentioned service classes UGS, rtPS, nrtPS and BE are also included in the MESH mode, thus enabling a seamless integration of both modes in one communication network of the IEEE standard 802.16.

Before going into detail, basic concepts of the frame structure based on TDD (TDD=Time Division Duplexing) supported in the MESH mode is described. In the MESH mode, the time axis is divided into frames of a specified length decided by the MESH base station BS. Each frame is in turn composed of a control subframe and a data subframe. The control subframe corresponds to the control time frame as defined in the claims and the data subframe corresponds to the data time frame as described in the claims. Detailed explanations with respect to the structure of those subframes can be found in document [1]. The control subframe is divided into a number of transmission opportunities and the data subframe is divided into a number of minislots which are time slots in the meaning of the claims. The MESH mode supports so-called coordinated centralized scheduling as well as coordinated and uncoordinated distributed scheduling for allocating bandwidth for transmission on individual links in the MESH mode of operation. The MESH configuration specifies a maximum percentage of minislots in the data subframe allocated to centralized scheduling. The remainder of the data substructure as well as any minislots not occupied by the current centralized schedule can be used for distributed scheduling.

In centralized scheduling, the bandwidth is managed in a more centralized manner than when using distributed scheduling. Thus, although the computation of the actual transmission schedule is done by the individual nodes independently, the grants for each individual node are controlled centrally by the base station BS in coordinated centralized scheduling. The base station BS uses centralized scheduling to manage and allocate bandwidth for transmissions up and down a scheduling tree from the base station BS to the subscriber station SS up to a specified maximum hop limit. The routing tree is advertised by the base station BS periodically using MSH-CSCF messages. The base station BS in the mesh network gathers resource requests from individual subscriber stations SS within the maximum hop range. Each subscriber station SS in the scheduling tree accumulates the requests from its children and adds to it its own requirement for uplink bandwidth before forwarding the request upwards along the scheduling tree (uplink here implies transmission along a link in the scheduling tree from a subscriber station SS to another subscriber station SS that is closer to the base station, downlink here refers to a transmission down the tree in the opposite direction). The base station BS collects all the requests and transmits the grants to its children. The grants for each individual subscriber station SS are then propagated down the scheduling tree hop by hop. Nodes use so-called MSH-CSCH messages to propagate requests and grants for centralized scheduling.

Distributed scheduling is used by a node in the wireless network to reserve bandwidth for transmission on a link to any other neighboring nodes. Nodes use distributed scheduling to coordinate their transmission in their two-hop neighborhood. The nodes use a distributed election algorithm to compete for transmission opportunities in the schedule control subframe. A pseudo-random function (the MESH election algorithms is specified in the 802.16 standard), with the nodes' identifiers of the competitors and the transmission opportunity number as input determines the winning node. The losing nodes compete for the next DSCH transmission opportunity until they win. The parameter XmtHoldoffExponent of each node determines the magnitude of transmission opportunities a node has to wait after sending a distributed scheduling message named MSH-DSCH in a won transmission opportunity. Details as to the computation of the hold off period can be found in document [1].

When using coordinated distributed scheduling, the nodes broadcast their individual schedules (available bandwidth resources, bandwidth requests, and bandwidth grants) using transmission opportunities won by the node in the schedule control subframe. The MESH election algorithm ensures that, when a node wins a transmission opportunity in the schedule control subframe for transmission, no other node in its two-hop neighborhood will simultaneously transmit. Thus, it is ensured that the scheduling information transmitted by a node in the schedule control subframe can be received by all of the neighboring nodes. To enable a conflict free schedule to be negotiated, each node maintains the status of all individual minislots in the frame. Summarized, the schedule negotiated using coordinated distributed scheduling is such that it does not lead to conflict with any of the existing data transmission schedules in the two-hop neighborhood of the transmitting node.

Contrary to the coordinated scheduling, nodes can also establish their transmission schedule by directed uncoordinated requests and grants between two nodes. This type of scheduling is called uncoordinated distributed scheduling. In contrast to coordinated distributed scheduling requests and grants which are sent in the schedule control subframe, the uncoordinated requests and grants are sent in the data subframe. When a node wants to reserve slots for transmission to a neighbor node based on uncoordinated distributed scheduling, they exchange scheduling information using time slots in the data subframe reserved for transmissions between the two nodes. Nodes individually need to ensure that their scheduled transmissions do not cause collisions with the data as well as with control traffic scheduled by any other node in their two-hop neighborhood. Transmissions in the data subframe using slots reserved for transmission to a particular neighbor may not be received by all the other neighbors due to other simultaneous transmissions. Thus, the schedule negotiated using the data subframe in uncoordinated scheduling may not be known to all the neighbors of the nodes involved in the uncoordinated schedule. The neighbors of these nodes may then schedule conflicting transmissions due to lack of the above uncoordinated schedule information. Hence, uncoordinated scheduling may lead to collisions and is not suitable for long term bandwidth reservations. Nodes use the above mentioned MSH-DSCH messages to transmit the bandwidth requests and grants and to negotiate schedules when using both coordinated as well as uncoordinated distributed scheduling.

The QoS architecture according to various embodiments as described in the following uses distributed scheduling in order to map the service classes in the PMP mode to the MESH mode. Nevertheless, the various embodiments are easily extensible and can be adapted for use in centralized scheduling. The architecture of the embodiment as described hereinafter uses a combination of coordinated distributed scheduling and uncoordinated distributed scheduling to efficiently manage the bandwidth in the network and the mesh node.

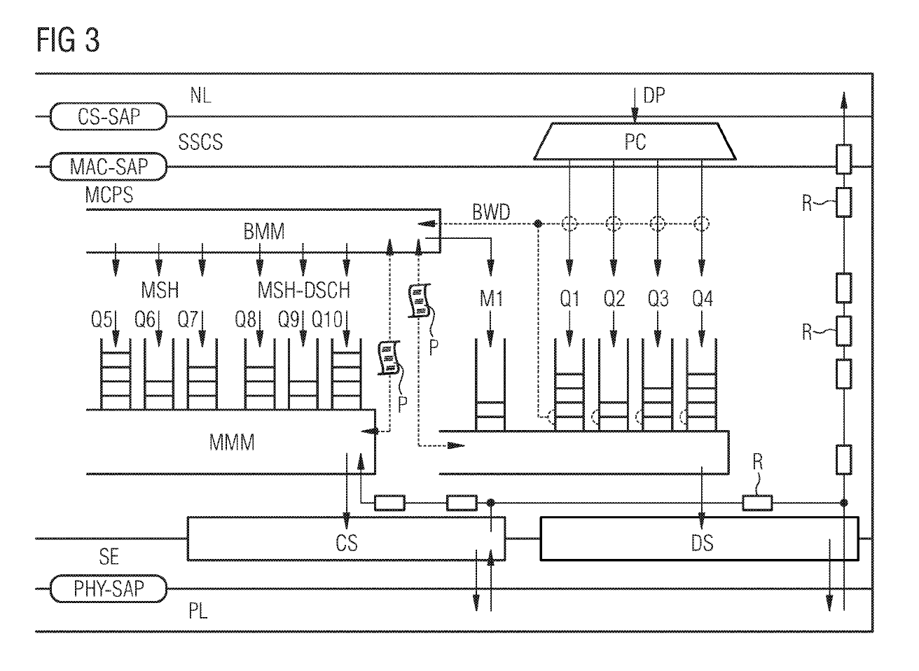

FIG. 3 shows a diagram illustrating a QoS architecture based on various embodiments for efficient management of bandwidth in the MESH mode. FIG. 3 shows the management of data packets in a node SS or BS operated in the MESH mode. Particularly, FIG. 3 shows the interaction between the data transmission on the lowest physical layer PL and the higher layers, namely the security sublayer SE, the MAC common part sublayer MCPS, the service specific convergence sublayer SSCS and the network layer NL. The layers SE, MCPS and SSCS altogether form the medium access control layer MAC. In FIG. 3, the flows of MAC protocol data units as well as of service data units are indicated by drawn through arrows whereas internal control flows are indicated by dashed arrows. Furthermore, for illustrative purposes, data packets are indicated by rectangles on arrows drawn with solid linetype. Some of those rectangles are designated with reference sign R for illustrative purposes. Furthermore, FIG. 3 includes the interface PHY-SAP between the physical layer PL and the security sublayer SE, the interface MAC-SAP between the MAC common part sublayer MCPS and the service specific convergence sublayer SSCS as well as the interface CS-SAP between the service specific convergence sublayer SSCS and the network layer NL. In the embodiment described herein, the network layer NL uses IP (IP=Internet Protocol) as the network layer protocol. Data packets on the network layer NL are designated as DP and are classified by a packet classifier PC. The module PC provides the functionality of the service specific convergence layer as defined in the IEEE standard 802.16 (see document [1]). The packet classifier PC classifies data packets from the network layer based on information in those data packets. Particularly, the IP TOS field (TOS=Type of Service) of the data packets is mapped to corresponding values assigned to the fields of the mesh CID specified in the MAC protocol data unit.

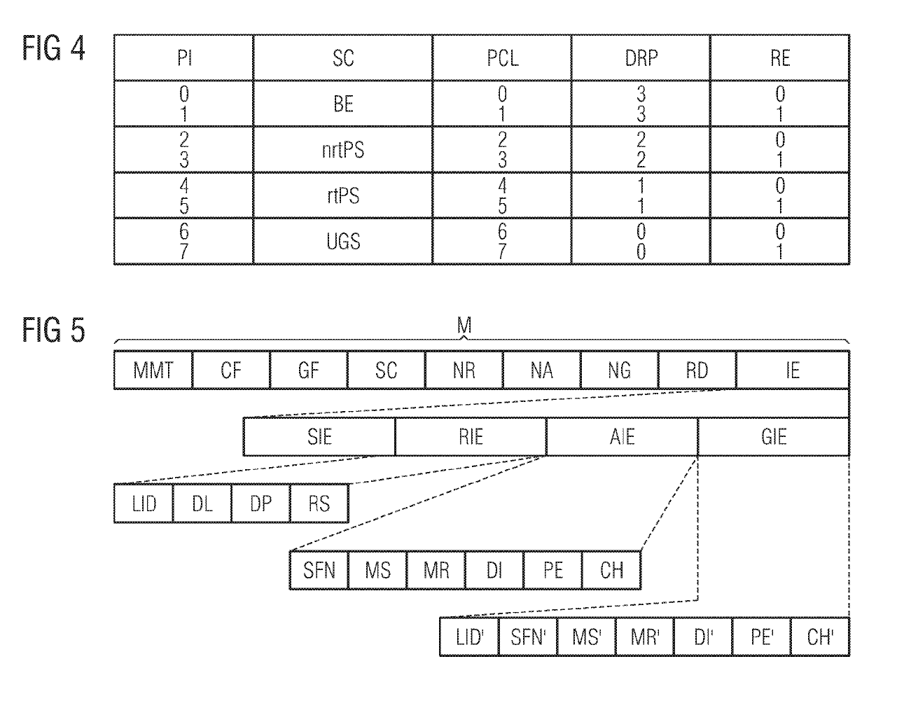

FIG. 4 shows a table indicating a possible mapping from the IP type of service TOS included in the data packets of the network layer NL to service classes and corresponding field values in the mesh CID. In column PI, the values of the IP type of service are indicated. The values lie between 0 and 7. Column SC indicates the different service classes BE, nrtPS, rtPS and UGS which have already been explained above. Column PCL indicates the values 0 to 7 of the 3 bit Priority/Class field in the MESH connection identifier CID. Column DRP indicates the 2 bit Drop Precedence field of the MESH connection identifier CID which may assume values between 0 and 3. Furthermore, column RE indicates the Reliability field of the MESH connection identifier CID which is a 1 bit field and can assume the values 0 and 1. All the above mentioned CID fields are well known in the IEEE standard 802.16 and, thus, are not explained in more detail herein. As can be seen from FIG. 4, the TOS values 0 and 1 refer to the service class BE and are indicated by the values PCL=0, DP=3, RE=0 and PCL=1, DP=3, RE=1 in the MESH CID, respectively. Furthermore, the TOS values 2 and 3 correspond to the service class nrtPS and are mapped to the values PCL=2, DP=2, RE=0 and PCL=3, DP=2, RE=1 in the MESH CID, respectively. The TOS values 4 and 5 correspond to the service class rtPS and are mapped to the values PCL=4, DP=1, RE=0 and PCL=5, DP=1, RE=1 in the MESH CID, respectively. Eventually, the TOS values 6 and 7 correspond to the service class UGS and are mapped to the values PCL=6, DP=0, RE=0 and PCL=7, DP=0, RE=1 in the MESH CID, respectively. The mapping shown in FIG. 4 is only an example and different mappings may be used. Furthermore, similar mapping functions may be implemented for other network protocols.

After classification of the data received from the network layer NL in the packet classifier PC, the packets are sent to a data management module DMM shown in FIG. 3. This module enqueues the arriving packets in corresponding queues Q1 to Q4. Each queue corresponds to a service class in which the respective packet is classified. Q1 refers to the service class UGS, Q2 to the service class rtPS, Q3 to the service class nrtPS and Q4 to the service class BE. Based on the congestion situation, the data management module DMM may also decide which packets may be dropped. Besides handling the data received for a transmission from the upper layers, the module DMM also manages the MSH-DSCH messages to be transmitted in the data subframe based on uncoordinated distributed scheduling. Those messages are indicated as M1 in FIG. 3 and form control messages for data packets of the rtPS service class. The data management module DMM keeps an account of the minislots reserved for transmission for each link to a neighbor of a node. It then sends the appropriate data packets from its queues for transmission on the wireless medium to the lower layer in a minislot reserved for transmission. Hence, the data management module DMM interacts with the minislots of the data subframe which is designated as DS in FIG. 3.

The data management module DMM can deploy sophisticated queuing and scheduling algorithms internally in order to meet the QoS requirements of the different types of traffic in its queues. For example, a simple weighted fair queuing (WFQ) scheduler which is well known in the prior art may be used. This simple scheduler services the MSH-DSCH queue including the MAC management messages M1 with a higher priority than the data queues Q1 to Q4. Within the data queues, the WFQ scheduler serves the UGS queue Q1, the rtPS queue Q2, the nrtPS queue Q3 and the BE queue Q4 with weights in decreasing order. The data management module DMM can use an admission control policy and a QoS scheduling scheme similar or identical to the one described in document [2] to meet hard per-hop QoS requirements for each kind of traffic. The whole disclosure of document [2] is incorporated by reference in this application. Thus, the data management module DMM is responsible for handling all transmissions during the data subframe. In addition, this module keeps a running estimate of the incoming data rate in each queue and, based on the policy to be implemented, notifies a bandwidth management module BMM of the current bandwidth requirements for each class of traffic. To do so, corresponding bandwidth demands BWD are sent from the data management module DMM to the bandwidth management module BMM.

The bandwidth management module BMM interacts with a MAC management module MMM handling all kinds of MAC management messages. Particularly, the module MMM handles MAC management messages received from the lower layer. MAC management messages are used for performing a so-called three-way handshake including a request, a grant and a grant-confirmation. This three-way handshake is used for reserving time slots in the data subframe for data transmission. To do so, a node sends a request for time slots to another node, the other node grants the request and, upon grant-confirmation, the respective time slots are reserved for data transmission of specific data packets. For example, if a MAC management message corresponds to a bandwidth request or a grant or a grant-confirmation, the MAC management module MMM updates the respective internal tables and extracts the relevant parameters of the message, i.e. the information elements IEs contained in the message. The structure of the MAC management messages and their information elements IEs will be described in more detail later on. The parameters extracted by the MAC management module MMM are sent to the bandwidth management module BMM for further processing when required. In addition, the MAC management module MMM is also responsible for processing MAC management messages received during the network control subframe which is indicated as CS in FIG. 3 and used for transmitting control messages. The module MMM maintains information about the schedules of the neighbors, the node identifiers of the neighbors, details about the physical two-hop neighborhood, the link IDs assigned for transmission to and reception from a neighboring node. Furthermore, the MAC management module is responsible for executing the mesh election algorithm which is specified in the IEEE standard 802.16. This algorithms is used to decide if management messages may be transmitted in a given transmission opportunity in the control subframe.

In the QoS architecture shown in FIG. 3, the concept of traffic classified as belonging to various data scheduling services is introduced. To do so, the nodes in the communication network distinguish the control messages MSH-DSCH and find out the service class to which the requests contained in the MSH-DSCH message correspond. This enables the bandwidth management module BMM at the node receiving the MSH-DSCH request to give an appropriate grant based on the expected traffic behavior. For example, when the requested bandwidth is to serve traffic on service class UGS (constant bit rate traffic with time synchronization requirements between sender and receiver), it is better to grant a fixed number of time slots in the data subframe DS for a longer period of time as the data traffic can be expected to be sent at a constant bit rate for a longer period. The messages for centralized scheduling generated by the bandwidth management module BMM are designated as MSH in FIG. 3 and are scheduled in respective queues Q5, Q6 and Q7 in the MAC management module MMM. Q5 refers to NCFG messages, Q6 refers to CSCH messages and Q7 refers to CSCF messages which are well-known messages in centralized scheduling according to the IEEE standard 802.16. Furthermore, the messages for a distributed scheduling generated by the bandwidth management module BMM are designated as MSH-DSCH in FIG. 3 where queue Q8 refers to messages with respect to the service class UGS, queue Q9 refers to messages with respect to the service class nrtPS and queue Q10 refers to messages with respect to the service class BE. Furthermore, parameters with respect to the service classes exchanged between the bandwidth module BMM and the MAC management module MMM as well as between the bandwidth management module BMM and the data management module DMM are designated as P in FIG. 3.

FIG. 5 shows the structure of a MSH-DSCH message used for uncoordinated and coordinated distributed scheduling according to various embodiments. The structure of the message shown in FIG. 5 is well known so that a detailed explanation of the meaning of the fields is not given in the following. The whole MSH-DSCH message is designated with reference numeral M and comprises several fields, namely an 8-bit field MMT for Management Message Type, a 1-bit field CF for Coordination Flag, a 1-bit field for Grant/Request Flag GF, a 6-bit field SC for Sequence Counter, a 4-bit field NR for Number of Request IEs (IE=Information Element), a 4-bit field NA for Number of Availability IEs, a 6-bit field NG for Number of Grant IEs, a 2-bit field RD for Reserved and a field IE for Information Elements which has variable bit length. In the embodiment described herein, the field RD is used in order to specify to which of the service classes UGS, rtPS, nrtPS and BE the MSH-DSCH message M refers.

The field IE includes four subfields, namely the field SIE specifying the MSH-DSCH_Scheduling_IEs and having variable bit length, the 20-bit field RIE specifying the MSH-DSCH_Request_IEs, the 32-bit field AIE specifying the MSH-DSCH_Availablity_IEs and the 40-bit field GIE specifying the MSH-DSCH_Grant_IEs. Those fields are well known and used for defining how many slots are requested from one node, how many slots are available in one node and how many slots are granted in a node in response to a request. The subfields SIE, RIE, AIE and GIE are used for performing the well-known three-way handshake for coordinated and uncoordinated distributed scheduling in the MESH mode. The field SIE indicates the minislots to be scheduled and the field is used when the coordination flag CF is set to 0. The field RIE comprises for each request the corresponding MSH-DSCH_Request_IEs. Hence, this field can be written as a loop as follows:

For (i=0; i<No_Request; ++i)

### MSH-DSCH_Request_IE( )

No_Request refers to the number of requests. The field RIE comprises four subfields. Those subfields are an 8-bit field LID for Link ID, an 8-bit field DL for Demand Level, a 3-bit field for Demand Persistence and a 1-bit field RS for Reserved.

The value of the field DP indicates for how many subsequent data subframes minislots are to be reserved and the values of this field are associated with reserved minislots as follows:

0=cancel a reservation performed previously for minislots in subsequent data frames
1=reserve minislots for a single subsequent data subframe
2=reserve minislots for 2 subsequent data subframes
3=reserve minislots for 4 subsequent data subframes
4=reserve minislots for 8 subsequent data subframes
5=reserve minislots for 32 subsequent data subframes
6=reserve minislots for 128 subsequent data subframes
7=good until cancelled or reduced, i.e. reserve minislots for all future subsequent data subframes until a request for cancelling or reducing the reservation is received.

The field AIE indicates for a number of availabilities transmitted in the message the corresponding available minislots. Hence, the field AIE can be written as a loop as follows:

For (i=0; i<No_Availability; ++i)

### MSH-DSCH_Availablity_IE( )

No_Availability corresponds to the number of availabilities. The field AIE is divided in 6 subfields. Those subfields include an 8-bit field SFN referring to the Start Frame Number, an 8-bit field MS referring to the Minislot Start, a 7-bit field MR referring to the Minislot Range, a 2-bit field DI referring to the Direction, a 3-bit field PE referring to the Persistence and a 4-bit field CH referring to the Channel.

The 2-bit field DI indicates the availability status of the minislot range indicated by the field MR. The meaning of the values of the field DI are as follows:

0=minislot range is unavailable
1=available for transmission in this minislot range
2=available for reception in this minislot range
3=available for either transmission or reception

The field GIE includes for each grant the corresponding granted minislots. Hence, this field can be written as a loop as follows:

For (i=0; i<No_Grant; ++i)

### MSH-DSCH_grant_IE( )

No_Grant refers to the number of grants. The field GIE includes seven subfields. Those subfields are an 8-bit field LID′ for the Link ID, an 8-bit field SFN′ for a Start Frame Number, an 8-bit field MS′ for Minislot Start, an 8-bit field MR′ for Minislot Range, a 1-bit field DI′ for Direction, a 3-bit field PE′ for Persistence and a 4-bit field CH′ for Channel.

The bandwidth management module BMM shown in FIG. 3 is responsible for generating bandwidth requests when more bandwidth is required, or generating cancel requests for free bandwidth when it is no longer required. It is also responsible for processing bandwidth requests received from the neighboring nodes and taking appropriate action when a grant or grant-confirmation is received. All the above requests, grants and grant-confirmations are sent as corresponding information elements within the MSH-DSCH message shown in FIG. 5. The bandwidth management module BMM receives information about instantaneous bandwidth demand from the data management module DMM. The bandwidth management module DMM maintains internally a set of MSH-DSCH_Availablity_IEs (see FIG. 5). The complete set of MSH-DSCH_Availablity_IEs describes the local status of individual minislots over all frames in the future. When generating a MSH-DSCH message to request bandwidth for transmission, the bandwidth management module BMM creates a MSH-DSCH_Request_IE (see FIG. 5) describing the amount of minislots required (specified by the demand level field DL in the MSH-DSCH_Request_IE) in a frame and the number of frames over which the bandwidth is required (denoted by the demand persistence field DP in the MSH-DSCH_Request_IE). Due to the classification of traffic into the different service classes UGS, rtPS, nrtPS and BE, the bandwidth management module BMM is able to estimate the arrival characteristics of traffic and make an intelligent choice for the persistence value of the field PE to be sent with the request. In an embodiment, the bandwidth management module BMM requests minislots with persistence 7 (i.e. good until cancelled or reduced) only when the data scheduling service associated with the traffic is UGS. This maps the UGS service provided in the PMP mode where a node receives a constant amount of bandwidth for the lifetime of the connection.

In the PMP mode, the rtPS scheduling service is meant to support real-time data streams consisting of variable-sized data packets arriving periodically. To support such a service in the MESH mode, one requires opportunities for requesting bandwidth in real-time. Using coordinated distributed scheduling a node, however, has to compete with other nodes in its two-hop neighborhood for transmission opportunities in which a bandwidth request can be sent. Nodes using distributed scheduling need to complete the three-way request/grant/grant-confirmation handshake procedure before data can be transmitted using the reserved bandwidth. It is thus not possible to complete the handshake in real-time if only coordinated distributed scheduling is used and the topology is highly connected. Hence, according to one embodiment, the QoS architecture reserves at least a single slot on each link to a neighbor with persistence 7 (i.e. the slot is available for transmission all the time) in order to ensure an upper bound of the handshake delay. This slot can then be used for transmitting MSH-DSCH messages containing requests and grants for the rtPS service class in the data subframe. This ensures that the handshake completes in the next few frame irrespective of the topology or the value of XmtHoldoffExponent. Hence, as can be seen from FIG. 3, the bandwidth management module BMM sends all MSH-DSCH messages for the rtPS service class to the data management module DMM for transmission. In addition, internally, to ensure a minimum delay, the traffic from the rtPS class can borrow (be transmitted in) bandwidth reserved for UGS traffic. UGS traffic can then borrow bandwidth back from the reserved bandwidth for the rtPS class as soon as the uncoordinated scheduling handshake is over. A characteristic of rtPS is that it has a variable bit rate. Thus, it is highly inefficient to request a fixed amount of slots for transmission for rtPS with persistence 7. This may lead to many of the slots being unused in many frames. Hence, in an embodiment, an estimation of the number of slots required per frame is used to send the arriving rtPS data, and those slots are requested with a persistence less than 7, particularly with the persistence 5 (reservation is valid for 32 frames). Using uncoordinated scheduling to reserve bandwidth for a long term is not recommended as it may lead to collisions.

For the nrtPS class, periodic request opportunities which need not be in real-time are required. nrtPS traffic is moreover delay tolerant. Thus, in an embodiment, an estimator to find out the amount of minislots required per frame is used and requests are sent with a persistence smaller than 7. As a result, the exact amount of bandwidth required for transmitting nrtPS data can be reserved periodically (using transmission opportunities in the schedule control subframe). The BE service class is very similar to the nrtPS service class with the difference that it is served on a space-available basis. Thus, for BE the estimated number of minislots is reserved with a persistence less than 7. The difference to nrtPS is that traffic belonging to UGS and rtPS are allowed to borrow bandwidth reserved for BE traffic.

Every request has to be accompanied by a set of MSH-DSCH_Availablity_IEs as shown in FIG. 5. A maximum of 16 MSH-DSCH_Availablity_IEs may be transmitted with the request. This set of MSH-DSCH_Availablity_IEs notifies the receiver of the request of the minislot range within which the bandwidth is to be granted. Thus, a poor choice of the set of MSH-DSCH_Availablity_IEs to transmit with the request will lead to a failure of the request. In an embodiment, a subset of MSH-DSCH_availability_IEs at the node which is just able to satisfy the request is selected. Then a set of 16 of the above MSH-DSCH_Availablity_IEs is selected randomly to be sent with the request. For better understanding, an example with respect to the meaning of a MSH-DSCH_Availablity_IE just satisfying the request is given in the following.

Assume that a single slot for all future frames is needed, then all availability information elements with persistence less than 7 are not able to satisfy this request. Now consider MSH-DSCH_Availablity_IEs, all having one minislot and persistence 7, however a different value for the direction field DI shown in FIG. 5. Evidently, the transmission is not possible in minislots with direction 0 (unavailable) or 2 (available for reception only). Thus, MSH-DSCH_Availablity_IEs having direction 0 or 2 will not be able to satisfy the request at the sender and should not be sent along with the request. The MSH-DSCH_Availablity_IEs with direction values 1 and 3 from the above will be able to satisfy the request and may be sent along with the request. A poor choice may not only lead to a failure of the handshake but also result in less slots with status 3 (available for both transmission and reception) and 1 (transmit available) remaining in the nodes in the network.

On receiving a request, the bandwidth management module BMM is also responsible for processing the request to find a mutually suitable set of slots for a grant which is able to satisfy the request. The internal structure of a grant information element MSH-DSCH_Grant_IE is shown in FIG. 5 and has already been described above. A poor choice for the grant would be for example a grant starting at a frame before the three-way handshake can be completed, this means that the slots in that range will remain unused (data transmission using the granted slots may not start until the three-way handshake is complete as required by the standard). On the other hand, if the grant starts from a frame much in the future after completion of the three-way handshake it leads to additional delay before a transmission can start. In an embodiment, grants are selected which would start at least four frames in the future after reception of the request.

A three-way handshake including request, grant and grant-confirmation may fail after the grant has been sent. Nodes in the neighborhood of the node sending the grant update the status of the minislot range being granted as being in use. Thus, these slots are no longer available for transmission at the nodes receiving the grant. If the grant is sent with persistence 7 (good until cancelled) these slots will not be available for transmission for all frames in the future at the nodes which receive the grant. When the handshake now fails, the grant-confirmation will not be sent, and hence the slots will never be used for data transmission. Despite the fact that the slots will not be used, the IEEE 802.16 standard currently lacks a mechanism to indicate that the grant sent previously has become invalid (due to failure of the handshake). Thus, these slots are lost forever. To avoid the above phenomenon, a soft-state reservation mechanism can be used. However, in an embodiment, an explicit revoke of the grant is implemented in the MSH-DSCH-message. Particularly, the MSH-DSCH_Grant_IE as indicated in the field GIE in FIG. 5 is modified to include a revoke bit. When a grant-confirmation (e.g. for a grant with persistence 7) is not received within a specified time-out, the node which sent the grant sends a copy of the grant with persistence or with the revoke bit set. This message may be called grant-revoke message. It enables the bandwidth management module BMM at nodes receiving the grant-revoke to take appropriate actions and update the status of the MSH-DSCH_Availablity_IEs stored locally. No grant-revoke confirmation is sent if the grant-confirmation was not sent either.

The use of a revoke bit is optional. It is also possible to free granted timeslots by the use of a grant revoke message not specifying a revoke bit. This grant revoke message is just a copy of the grant with persistence 0. As a consequence, the node receiving this grant revoke message will scan the stored set of grants for which no confirm has been sent yet to see if the grant revoke message cancels one of the pending grants. Those pending grants will then be deleted and no grant-confirmation will be sent for those grants.

Summarized, there is no need to use a revoke bit. Nevertheless, the use of such a revoke bit allows optimized mechanisms for slot status update to be implemented. Particularly, only when the revoke bit is set, the node receiving the grant revoke message will scan the stored set of pending grants. This will not be done when the grant revoke bit is not set because in such a case this received message will correspond to a normal grant cancel specifying the cancellation of previously granted time slots. The procedure for cancelling time slots is well known and will not be described in more detail herein.

The bandwidth management module BMM is also responsible for maintaining an up to date status of the MSH-DSCH_Availablity_IEs stored locally at a node. This involves updating the status when receiving or transmitting either a grant or a grant-confirmation.

The various embodiments as described above provide a novel mechanism for managing bandwidth in the 802.16 MESH mode of operation with an aim to support the same service classes which are supported by the PMP mode, particularly the classes UGS, rtPS, nrtPS and BE. This is achieved by an appropriate handling of the three-way handshake for reserving minislots in dependency on the service class. Furthermore, the various embodiments include a bandwidth revocation mechanism which allows the recovery of bandwidth in case that a three-way handshake fails or in case of node failure in network.

### LITERATURE

[1] IEEE Computer Society and IEEE Microwave Theory and Techniques Society. 802.16 IEEE Standard for Local and metropolitan area networks, Part 16: Air Interface for Fixed Broadband Wireless Access Systems. IEEE Std. 802.16-2004 (October, 2004).
[2] K. Wongthavarawat and A. Ganz, Packet scheduling for QoS support in IEEE 802.16 broadband wireless access systems, International Journal of Communication Systems. 16, 81-96, (2003).

What is claimed is:

1. A method for data transmission in a mesh mode of a wireless communication network, the mesh mode enabling a decentralized transmission of data packets within data streams via communication links from one node to another node in the communication network, the method comprising:
classifying data streams in service classes specifying quality requirements for the data streams of the respective service class;
performing bandwidth reservations for data streams between nodes of a communication link, each bandwidth reservation being dependent on the service class of the data stream to be transmitted via the communication link and comprising the exchange of control messages for reserving time slots for transmitting the data stream of the service class in subsequent data time frames via the communication link;
scheduling the transmission of data streams via the communication link in dependency on the service classes of the data streams.

2. The method according to claim 1, wherein the data is transmitted as MAC protocol data units on the MAC layer in the mesh mode of the standard IEEE 802.16.

3. The method according to claim 2, wherein the control messages are MAC management messages, particularly MSH-DSCH messages.

4. The method according to claim 2, wherein a service class is mapped to values of one or more fields in the mesh connection identifier of a MAC protocol data unit or to values of at least one of the fields Reliability, Priority/Class, and Drop Precedence.

5. The method according to claim 1, wherein the bandwidths of the data streams are estimated and the bandwidth reservations depend on the estimated bandwidths of the data streams.

6. The method according to claim 1, wherein the service classes comprise a first service class for real-time data streams having variable-sized data packets issued periodically and wherein at least one time slot per communication link is reserved for all subsequent data time frames in order to transmit control messages of bandwidth reservations for data streams of the first service class.

7. The method according to claim 2, wherein the service classes comprise a first service class for real-time data streams having variable-sized data packets issued periodically and wherein at least one time slot per communication link is reserved for all subsequent data time frames in order to transmit control messages of bandwidth reservations for data streams of the first service class, and wherein the first service class corresponds to the rtPS service class in the PMP mode of the standard IEEE 802.16.

8. The method according to claim 6, wherein the bandwidth reservation for data streams of the first service class is valid for time slots of a finite number of subsequent data time frames.

9. The method according to claim 1, wherein the service classes comprise a second service class specifying real-time data streams having fixed-sized data packets issued periodically.

10. The method according to claim 6, wherein the service classes comprise a second service class specifying real-time data streams having fixed-sized data packets issued periodically, and wherein the time slots being reserved for data streams of the second service class are at least partially usable for transmitting at least one of control messages and data streams of the first service class.

11. The method according to claim 2, wherein the service classes comprise a second service class specifying real-time data streams having fixed-sized data packets issued periodically, and wherein the second service class corresponds to the UGS service class of the PMP mode of the standard IEEE 802.16.

12. The method according to claim 9, wherein the control messages of the bandwidth reservation for data streams of the second service class are exchanged in control time frames.

13. The method according to claim 9, wherein the bandwidth reservation for data streams of the second service class is valid for time slots of all subsequent data time frames in the future.

14. The method according to claim 1, wherein the service classes further comprise at least one of a third service class specifying non-real-time data streams having variable-sized data packets with a minimum data rate requirement and a fourth service class specifying non-real-time data streams without any data rate requirement.

15. The method according to claim 2, wherein the service classes further comprise at least one of a third service class specifying non-real-time data streams having variable-sized data packets with a minimum data rate requirement and a fourth service class specifying non-real-time data streams without any data rate requirement, and wherein the third service class corresponds to the nrtPS service class of the PMP mode of the standard IEEE 802.16 and/or the fourth service class corresponds to the BE service class of the PMP mode of the standard IEEE 802.16.

16. The method according to claim 14, wherein the bandwidth reservations for data streams of at least one of the third and fourth service class are valid for time slots of a finite number of subsequent data time frames.

17. The method according to claim 14, wherein the control messages of the bandwidth reservations for data streams of at least one of the third and fourth service class are exchanged in control time frames.

18. The method according to claim 14, wherein the service classes comprise a first service class for real-time data streams having variable-sized data packets issued periodically and wherein at least one time slot per communication link is reserved for all subsequent data time frames in order to transmit control messages of bandwidth reservations for data streams of the first service class, wherein the service classes comprise a second service class specifying real-time data streams having fixed-sized data packets issued periodically, and wherein the transmission of the data streams is scheduled by a weighted fair queuing scheduler such that the second and first and third and fourth data streams are served with weights in decreasing order.

19. The method according to claim 14, wherein the service classes comprise a first service class for real-time data streams having variable-sized data packets issued periodically and wherein at least one time slot per communication link is reserved for all subsequent data time frames in order to transmit control messages of bandwidth reservations for data streams of the first service class, wherein the service classes comprise a second service class specifying real-time data streams having fixed-sized data packets issued periodically, and wherein data streams of the first and second service classes are allowed to borrow bandwidth reserved for data streams of the fourth service class but not for data streams of the third service class.

20. The method according to claim 1, wherein the control messages in a data time frame are served with higher priority than the data streams in the data time frame.

21. The method according to claim 1, wherein the data streams are classified based on information in the network layer or in the IP layer.

22. The method according to claim 1, wherein the control messages exchanged during bandwidth reservation comprise messages for requesting, granting and grant-confirming reserved time slots and wherein a node having sent a control message for granting reserved time slots and not receiving a corresponding control message for grant-confirming within a predetermined time sends a grant revoke message for revoking the reservation of the reserved time slots.

23. The method according to claim 1, wherein a node not receiving data from another node in already reserved timeslots within a predefined time sends a grant revoke message for revoking the reservation of the reserved timeslots.

24. The method according to claim 22, wherein the grant revoke message specifies the time slots granted by the node in combination with a cancelling instruction.

25. The method according to claim 2, wherein the control messages exchanged during bandwidth reservation comprise messages for requesting, granting and grant-confirming reserved time slots and wherein a node having sent a control message for granting reserved time slots and not receiving a corresponding control message for grant-confirming within a predetermined time sends a grant revoke message for revoking the reservation of the reserved time slots, and wherein the grant revoke message is specified by a revoke bit in the grant information element of the MSH-DSCH message of the standard IEEE 802.16.

26. A Network node for data transmission in a mesh mode of a wireless communication network, the mesh mode enabling a decentralized transmission of data packets within data streams via communication links from the network node to other nodes in the communication network, wherein the network node comprises:
means for classifying data streams arriving in the network node in service classes specifying quality requirements for data streams of the respective service class;
means for managing bandwidth reservations for data streams, said bandwidth reservations being performed between the network node and neighboring nodes of a communication link, wherein each bandwidth reservation is dependent on the service class of the data stream to be transmitted via the communication link and comprising the exchange of control messages for reserving time slots for transmitting the data stream of the service class in subsequent data time frames via the communication link;
means for scheduling the transmission of data streams from the network node via the communication link in dependency on the service classes of the data streams.

27. The network node according to claim 26, wherein the data is transmitted as MAC protocol data units on the MAC layer in the mesh mode of the standard IEEE 802.16.

28. A communication network comprising several network nodes according to claim 26.
